(19) United States
(12) Patent Application Publication
(10) Pub. No.: US 2008/0243307 A1
(43) Pub. Date: Oct. 2, 2008

(54) Apparatus and Method for Generating and Controlling the Motion of a Robot

(75) Inventors: Marc Toussaint, Berlin (DE); Michael Gienger, Frankfurt (DE)

Correspondence Address: FENWICK & WEST LLP, SILICON VALLEY CENTER, 801 CALIFORNIA STREET, MOUNTAIN VIEW, CA, 94041, US

(73) Assignee: HONDA RESEARCH INSTITUTE EUROPE GMBH, Offenbach/Main (DE)

(21) Appl. No.: 12/050,948

(22) Filed: Mar. 19, 2008

(30) Foreign Application Priority Data
Mar. 26, 2007 (EP) 07104900

(51) Int. Cl. G05B 19/04

(52) U.S. Cl. 700/252; 700/254; 901/30

(57) ABSTRACT

A method for controlling a system or robot having at least one effector. An initial sequence of control points is computed. The system or the robot is evaluated by a global cost function that uses internal simulation based on the control points. The sequence of control points are updated based on the evaluation. The evaluation of the system or the robot and the updating of the sequence of control points are repeated until a given termination criterion is met.

### RELATED APPLICATIONS

This application claims priority under 35 U.S.C. §119(a) to European Patent Application number 07 104 900, filed on Mar. 26, 2007, which is incorporated by reference herein in its entirety. This application is related to U.S. patent application Ser. No. ______, filed on ______ (Attorney Dkt No.: 23077-13969); and U.S. patent application Ser. No. ______, filed on ______ (Attorney Dkt No.: 23077-13990), which are incorporated by reference herein in their entirety.

### FIELD OF THE INVENTION

The present invention relates to robotics, more specifically to the generation of control points or attractor points controlling the trajectory and internal parameters of a redundant task-level controller to produce globally optimal trajectories of robotic effectors.

### BACKGROUND OF THE INVENTION

Industrial robots generally comprise one or more effectors commonly in the form of manipulators. In humanoid robotics, the effectors are often defined in terms of reference points such as finger tips. The effector also includes the head of the humanoid robot that can be controlled to face a certain direction.

There are many ways to describe effector motions. For effector positions, x, y and z elements of a position vector are commonly chosen to describe the effector motions. For spatial orientations, the task is often described in Euler angles or quaternions. In many cases, special descriptions for a task are used. A common way of generating motions in a robotic system is to describe the path of the effector in task coordinates. This path is denoted as a task trajectory (TT) which is a continuous path describing the motion of a system. The trajectory may describe the path of the individual joints or a path represented in task coordinates.

The space described by the task coordinates is called the task space. For example, if the hand position of a robot in x, y and z direction is controlled, the task space has a dimension of three (3) and is defined these coordinates. The number of task coordinates is a measure of the dimensionality of the task to be performed. For example, if a robot hand is to be controlled, the task coordinates correspond to x, y and z coordinates of the robot hand. In the example of the robot hand, the dimensionality of the task is three (3).

In another example, the position and the orientation of the hand need to be controlled. The task coordinates in such cases are x, y and z elements for the position, and three angles for the orientation (e.g., Euler angles). In this case, the task has a dimension of six (6).

In a further example, if the motion is governed by individual joints moving within predefined limits, the control parameters may be composed of parameters describing a cost function that penalizes joint angles that deviate from their preferred position.

Additional controller parameters may influence the generated motion, but do not influence the tracking of the trajectory points. This is a feature of redundant robots. Such parameters include criteria such as avoiding joint limits and minimizing torque.

In other words, in addition to the task trajectory, the motion may be influenced by a set of control parameters that impose a desired behavior of the remaining degrees of freedom of the robotics system, the so-called null space. In other words, the null space is the space in which a motion does not influence the task space motion. For example, if a robot has seven (7) degrees of freedom, and the task vector is hand position represented by 3-dimensional elements, then the null space has four (4) dimensions. The system is redundant with respect to the task. All motion of the arm that does not interfere with the task motion is called the null space motion. Again, these null-space parameters may vary over time. The behaviour of the system is defined by the time evolution of these control parameters, i.e., the parameter trajectory (PT).

In high performance robotic systems, the time between two control cycles is typically in the order of 1-10 msec. Thus, following the above approach, the TT and the PT need to be specified in a very fine time resolution. Traditional trajectory optimization techniques attempt to compute optimal TTs on this fine time scale. In order to follow this trajectory, a control loop is employed which is not subject to the optimization process.

A possible approach to a more compact movement representation is to specify a finite set of control points. The TT and PT are then interpolated between these control points using spline (e.g., fifth order polynomials) or filtering techniques (e.g., computing trajectory points based on attractor dynamics). The advantage of using a control point-based trajectory representation is that a complex task trajectory and a large set of controller parameters are reduced into a set of discrete control points. This translates into a significant reduction of the command data that need to be generated.

The literature regarding robot trajectory optimization can be subdivided into two categories. One category deals with the generation of optimal trajectories with respect to time, smoothness or collisions. The employed optimization methods have a global character that makes it necessary to repetitively recompute the overall motion with different parameters. Such methods incur high computational costs. Therefore, in most cases, the methods cannot compute within the short time steps of a real-time controller implementation. The second category of literature recognizes the role of movement primitives in biology. The second class includes approaches to translate this idea to the realm of robotic control. Movement primitives are used as means to simplify programming of movements or to imitate learning in robotic systems. However, no global optimization of control parameters has yet been proposed.

Most approaches stemming from the first category are designed for industrial robots if the number of the joints equals the dimension of the optimization problem, there exists a unique mapping from task to joint space (inverse kinematics), and the overall behavior is uniquely defined. If, however, the number of joints is larger than the dimension of the task (redundancy), the movement is no longer defined uniquely. Redundant control algorithms use these characteristics to satisfy further criteria in the so-called null space of the motion. In many cases, criteria such as joint limit avoidance are used.

A. Heim et al., “Trajectory Optimization of Industrial Robots with Application to Computer-Aided Robotics and Robot Controllers,” Optimization (Journal), Vol. 47, pp. 407-420, which is incorporated by reference herein in its entirety, describes trajectories represented in a spline parameterization (Cubic splines). Examples are given for a spline parameterization at joint-levels and at task-levels. The spline parameters are computed for a predefined number of set points. The optimization algorithm finds the optimal set points for the given problem with respect to the dynamic model of the robot. The computed motion will be optimal in terms of the underlying dynamic model of the robot. The controller itself, however, is not considered. In this approach, the optimal trajectory is given as commands to the robot, and the robot motion control is responsible for ensuring the exact tracking.

M. Schlemmer and G. Gruebel, “Real-Time Collision-Free Trajectory Optimization of Robot Manipulators via Semi-Infinite Parameter Optimization,” International Journal of Robotics Research, Vol. 17, No. 9, pp. 1013-102, September 1998, which is incorporated by reference herein in its entirety, describes computing optimal solutions for a robot taking into account a large number of joints that may cause collisions with external objects and contribute to the dynamics of the robot. However, the trajectory is represented as a set of spline parameters at the joint level. In this way, the overall motion is uniquely defined and the controller is implicitly incorporated into the scheme. However, the optimized trajectory is not represented at the task level. Further, this approach does not optimize additional controller parameters.

Jianwei Zhang and Alois Knoll, “An Enhanced Optimization Approach for Generating Smooth Robot Trajectories in the Presence of Obstacles,” Proc. of the 1995 European Chinese Automation Conference, London, pp. 63-268, September 1995, which is incorporated by reference herein in its entirety, discloses a similar approach. In this article, set points are called subgoals, and B-splines at the joint level are optimized between these subgoals to generate a collision-free point-to-point motion. In this article, an adaptation of the number of subgoals is proposed if the goal cannot be reached without collisions.

Abdel-Malek et al., “Optimization-based trajectory planning of the human upper body,” Robotica (Journal), Cambridge University Press, 2006, which is incorporated by reference herein in its entirety, discloses generating optimal task-level trajectories with respect to a jerk measure (time derivative of acceleration). This criterion is known to generate motions that are very similar to human movements. However, the optimal solution is computed for the task, and the overall joint motion is not taken into account. In a second independent step, B-splines are optimized for the joint motions. For this purpose, a heuristic set of cost functions is used.

Previous literature on the concept of movement primitives include early works on motor primitives in frogs (for example, F. A. Mussa-Ivaldi, S. F. Giszter, and E. Bizzi, “Linear combinations of primitives in vertebrate motor control,” Neurobiology, 91:7534-7538, 1994; and E. Bizzi, A. d'Avella, P. Saltiel, and M. Tresch, “Modular organization of spinal motors systems,” The Neuroscientist, 8:437-442, 2002, which are incorporated by reference herein in their entirety). Inspired by these biological findings, several researches have adopted the concept of motor primitives in the realm of robotic movement generation. For instance, R. Amit and M. J. Mataric, “Parametric primitives for motor representation and control,” In Proc. of the Int. Conf. on Robotics and Automation (ICRA), pages 863-868, 2002, which is incorporated by reference herein its entirety, describes a model in which a reactive controller learns and outputs the attractor parameter of an underlying movement primitive. A. Ijspeert, J. Nakanishi, and S. Schaal, “Trajectory formation for imitation with nonlinear dynamical systems,” In Proc. of the IEEE Int. Conf. on Intelligent Robots and Systems, 2001; and S. Schaal, J. Peters, J. Nakanishi, and A. Ijspeert, “Control, planning, learning, and imitation with dynamic movement primitives” In Workshop on Bilateral Paradigms on Humans and Humanoids, IEEE Int. Conf. on Intelligent Robots and Systems, Las Vegas, Nev., 2003, which are incorporated by reference herein their entirety, focus on non-linear attractors and learning the nonlinearities, for example, to imitate observed movements.

The above approaches optimize the parameters of a single attractor system, for example, such that this single movement primitive imitates a teacher's movement as best as possible. Further, the above approaches use data generated from exploratory trials to train the attractor dynamics. Also, the above approaches do not address optimization under redundancy. That is, the conventional approaches do not distinguish between a task state x and a robot state q.

### SUMMARY OF THE INVENTION

It is an object of the present invention to address the problem of optimizing a sequence of control points each defining a movement segment to satisfy global optimality criteria.

It is another object of the present invention to use a given robot model and knowledge about the control architecture to derive analytic gradients for optimization.

It is yet another object of the present invention to provide an optimization scheme that accounts for the redundant inverse kinematics used in the control architecture that allows defining of arbitrary task spaces as a more compact representation of the movement.

One embodiment of the present invention provides a method for controlling a system having at least one effector. The method may comprise the steps of computing an initial sequence of control points, evaluating the system by a global cost function using internal simulation based on the control points, and updating the set of control points based on the evaluation. The last two steps are repeated until a given termination criterion is met.

The global cost function may comprise optimality criteria that are formulated such that an underlying attractor dynamics generate globally optimal trajectories. The timing of control points may be controlled by causal events.

The initial sequence of control points may be computed by linear interpolation from the initial effector position to the target position. The computation of the gradient may comprise the steps of forward simulating the robot's behavior and backward propagating the cost function. The set of control points may be updated using a standard optimization algorithm such as resilient backpropogation (RPROP), a Conjugate Gradient method or a stochastic search.

In one embodiment of the present invention, the optimality criteria for the control points may be formulated such that the underlying reactive attractor dynamics generate globally optimal trajectories. The resulting movement integrates the properties of smoothness and stability of the attractor dynamics with the globally optimality criteria. Unlike conventional optimization techniques, this optimization is performed on the lower-dimensional compact representation of control points and includes the underlying control loop as a subject of optimization.

In one embodiment of the present invention, the optimization scheme may be integrated into a real-time system so that the optimal motion is iteratively computed on the fly. The new control points are computed after the robot already started moving, and the newly generated control points may be applied during execution of the motion.

In one embodiment of the present invention, the task space may be parameterized. These parameters of the task space may also be optimized to find an optimal definition of the task space itself. In many cases, task space control points associated with a problem or cost function is left undefined. For example, for a bimanual grasping problem, the task space may either be composed of the absolute positions of both hands, or alternatively the task space may be composed of the relative and the mean position of both hands.

In one embodiment of the present invention, the number of control points may itself be optimized in order to find an optimal number of control points that solves a given problem. An optimal number of control point elements for each individual task element, i.e., an optimal task dimension, may also be found. For example, while the position of the hand is optimally controlled with three control points, the orientation of the hand is optimally controlled with five control points.

In one embodiment of the present invention, the timing of control points may be optimized by finding optimal timing between the control points. The timing may be parameterized and optimized together with the control points. Optimal timing may also be found at the level of individual elements of the control points. For example, the timing of applying the control points of the left hand may be different compared to the timing of control points for the right hand.

In one embodiment of the present invention, arbitrary motion criteria may be incorporated into the control point generation. That is, a set of criteria may be integrated into the computation of the control points. This set may be an arbitrary combination of kinematics and dynamic cost functions such as collision avoidance and momentum compensation. Another example is to optimize the similarity to an observed human motion. A third example would be intermediate conditions such as having the head face a certain direction while performing an overall motion.

In one embodiment of the present invention, the system or robot comprises at least one effector that may be controlled by commanding the attractor points in a time-synchronized manner. The optimized attractor points (control points) are commanded to the robot/system at discrete steps of time. This may be realized by an interface that synchronizes the robot's controller with time at which the attractor points must be applied. Alternatively, the system or robot may be controlled by commanding these attractor points synchronized by causal events. This may be the success signal of a phase to achieve a logically interrelated sequence of attractor movements.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the present invention can be readily understood by considering the following detailed description in conjunction with the accompanying drawings.

FIG. 1 is a schematic flow chart illustrating an overall scheme of optimizing control points, according to one embodiment of the present invention.

FIG. 2 is a a flow diagram illustrating a single optimization pass, according to one embodiment of the present invention.

FIG. 3 is a diagram illustrating a functional network of the control architecture, according to one embodiment of the present invention.

FIG. 4 illustrates back-propagation equations for a cost gradient, according to one embodiment of the present invention.

### DETAILED DESCRIPTION OF THE INVENTION

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

A preferred embodiment of the present invention is now described with reference to the figures where like reference numbers indicate identical or functionally similar elements.

The control points are represented following the approach of attractor dynamics. The attractor dynamics has the additional advantage of a robust reactive control cycle on the fine time resolution. The attractor of the fine time resolution may be modulated on a more coarse time scale by adjusting the control points.

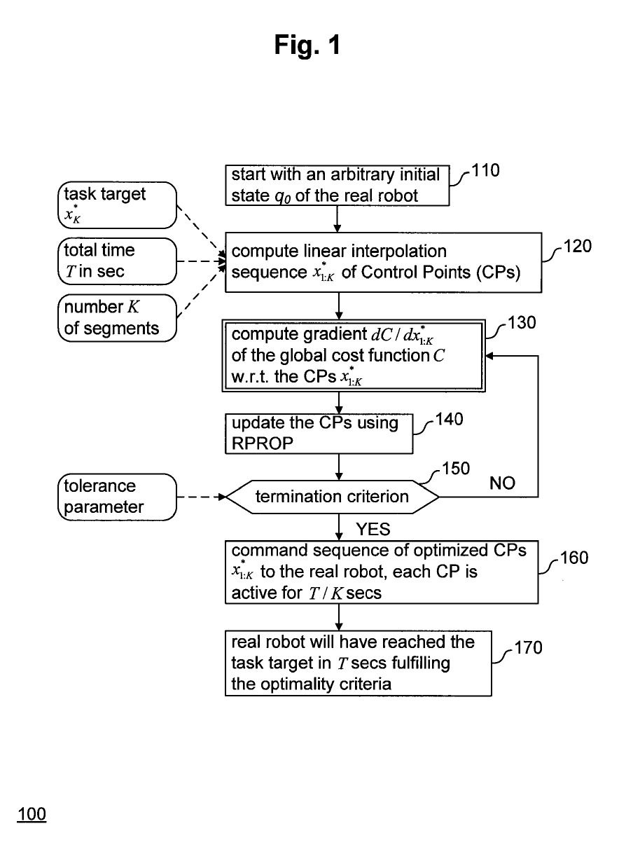

FIG. 1 illustrates a flow chart of a method according to one embodiment of the present invention. The problem is characterized by parameters (on the left-hand side) that define the target position x*_{K} of the effector, the time T at which the target is to be reached, and the number K of control points allowed during the execution of the movement. The problem is redundant because the effector target x*_{K} does not define a complete target robot state. Each control point divides the movement into one of K segments, each with a duration of T/K.

After an arbitrary starting position q₀ of the robot (q₀ defines all joint angles) is given in step 110, an initial sequence of control points x*_{1:K} is computed by linear interpolation from the initial effector position x₀ to the target x*_{K} in step 120.

A gradient of the global cost function with respect to the control points is then computed in step 130. The computation of the control points must exactly account for (simulate) the behavior of the real robot because the control points are sent as a movement command. The estimated change of global cost depends on the changes in the control points. The changes of a control point in early stages of the movement may have considerable effect on costs that are incurred later during the movement (delayed effect), for example, when disadvantageous velocities towards obstacles are produced.

In step 140, a state-of-the-art gradient based optimization step such as RProp may be used to update the x*_{1:K} after the gradient is computed, according to one embodiment of the present invention. A tolerance parameter may be employed to decide if the cost was minimized sufficiently.

After termination in step 150, the optimized sequence of control points x*_{1:K} may be output or sent to the real robot where each control point x*_{1:K} is active for the duration of one segment in step 160. The robot may follow a trajectory as internally simulated within the gradient computation procedure and complete the imposed effector target constraints and the cost criteria in step 170.

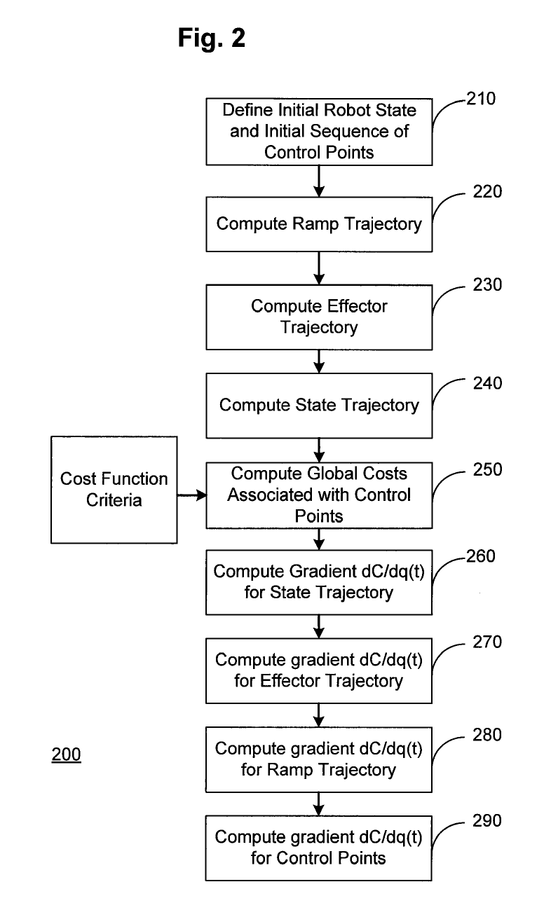

FIG. 2 is a flow chart illustrating a procedure 200 for computing a gradient having linear time complexity based on forward and backward propagations of gradients, according to one embodiment of the present invention. The procedure 200 has two distinctive passes: (i) the forward simulation of the robot's behavior; and (ii) the backward propagation of the cost gradient. The backward propagation allows computation of the exact gradient in the redundant attractor control scenario.

After an initial robot state q(t=0) and an initial sequence of control points x*_{1:K} are given in step 210, the forward simulation of the robot's behavior proceeds by forward iterating over the parameter t (time ranging from 0 to T) to compute the motion resulting from the attractor dynamics. In this particular example, the attractor dynamics are characterized by a ramp trajectory r(t) computed in step 220 from the given control points x*_{1:K} and a smoothed effector trajectory x(t) that is computed in step 230 using a ramp trajectory r(t), again iterating over t forward from time 0 to T. Then, the state trajectory q(t) is computed in step 240 using the smoothed effector trajectory x(t) by iterating over t from time 0 to T.

Using the state trajectory q(t) computed in this manner, the global costs C associated with the set of control points under investigation are computed in step 250. Here, parameters of the cost function may provide a weighting for motion or cost criteria comprising collision, smoothness and null space criteria.

Then, the cost gradient is backward propagated in the second pass. First, the gradient dC/dq(t) is computed in step 260 with respect to the state trajectory q(t), iterating over t from time T to 0. In the next step, the gradient dC/dx(t) is computed in step 270 with respect to the effector trajectory x(t), iterating over t from time T to 0. Then, the gradient dC/dr(t) is computed in step 280 with respect to the ramp trajectory r(t) and finally the gradient dC/d x*_{1:K} is computed in step 290 with respect to the control points.

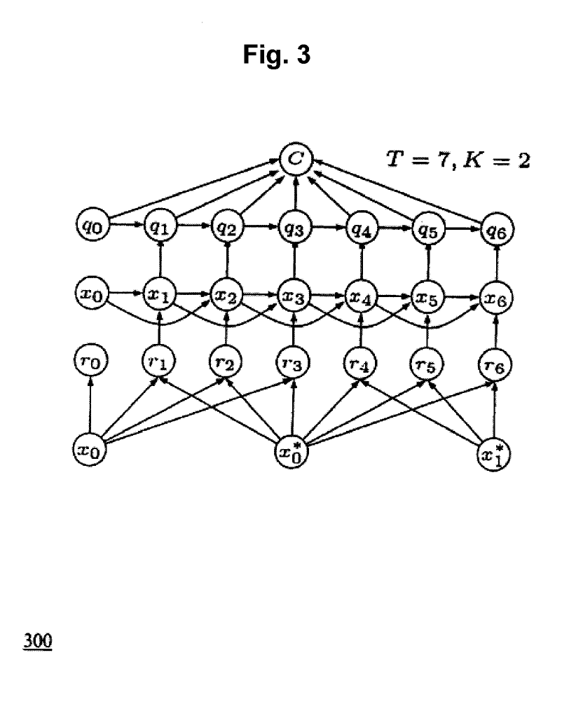

FIG. 3 is a diagram illustrating a functional network of the control architecture, according to one embodiment of the present invention. The precise equations for the above backward propagation may be derived from the structure of the functional dependencies between the different levels of representations (which are the level of control points, the ramp trajectory, the smoothed effector trajectory, and the robot state trajectory).

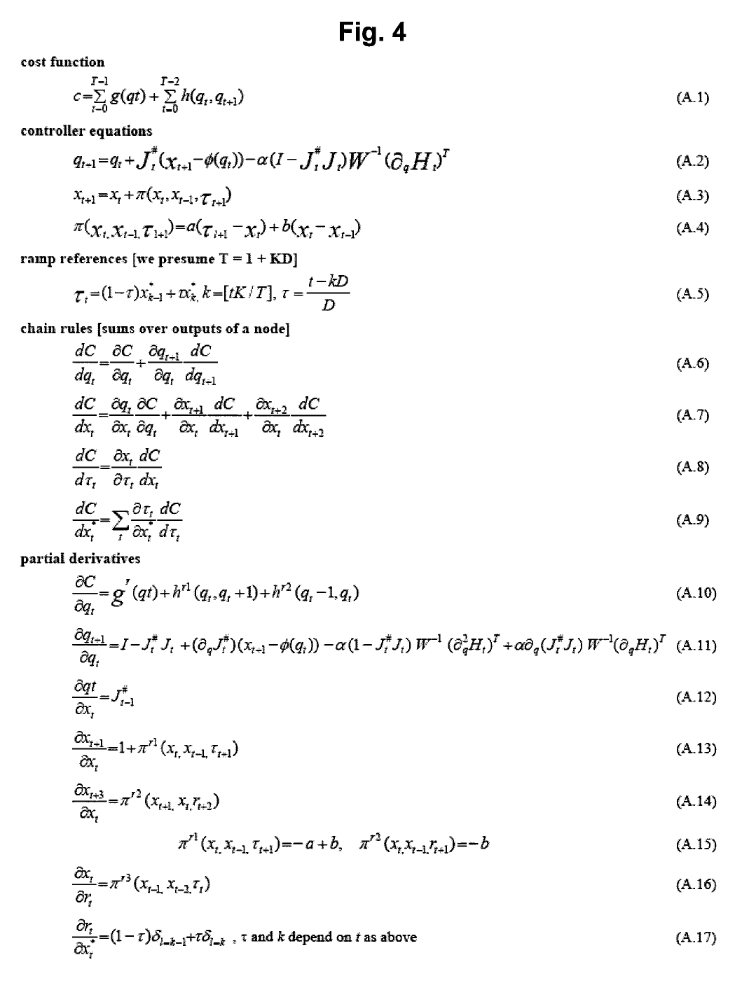

FIG. 4 is a diagram illustrating the exact dependencies and the back-propagation equations, according to one embodiment of the present invention.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A computer based method of controlling at least one of a system or robot including at least one effector, comprising:
(a) computing an initial sequence of control points;
(b) evaluating the at least one of the system or the robot by computing a global cost function that uses internal simulation based on the control points;
(c) updating the initial sequence to form a current sequence of the control points based on the evaluation;
(d) repeating steps (b) and (c) until a termination criterion is met; and
(e) outputting the current sequence of the control points after the termination criterion is met.

2. The method of claim 1, wherein the global cost function comprises optimality criteria formulated such that underlying reactive attractor dynamics generate globally optimal trajectories.

3. The method of claim 1, wherein timing of control points is controlled by causal events.

4. The method of claim 1, wherein the initial sequence is computed by linearly interpolating from an initial position of the at least one effector to a target position.

5. The method of claim 1, wherein computing the global cost function comprises:
forward simulating behaviour of the at least one of the system or the robot; and
backward propagating cost function gradients.

6. The method of claim 1, wherein the initial and current sequence of the control points is updated using at least one of resilient backpropogation, a Conjugate Gradient method or a stochastic search.

7. The method of claim 1, wherein the updated control points are computed after the system starts moving, the updated control points applied during execution of the movements.

8. The method of claim 1, wherein the control points comprise task parameters that are also optimized.

9. The method of claim 1, wherein a number of control points is optimized.

10. The method of claim 1, wherein timing of the control points is optimized.

11. The method of claim 1, wherein the global cost function comprises a combination of optimality criteria representing collision avoidance, momentum compensation, and similarity to observed human motions.

12. The method of claim 1, wherein the control points are provided to the at least one of the system or the robot in a time-synchronous manner.

13. The method of claim 1 wherein the control points provided to the at least one of the system or the robot as synchronized by causal events.

14. A computer readable storage medium structured to store instructions executable by a processing system, the instructions when executed cause the processing system to:
(a) compute an initial sequence of control points;
(b) evaluate at least one of a system or a robot by computing a global cost function that uses internal simulation based on the control points;
(c) update the initial sequence to form a current sequence of the control points based on the evaluation;
(d) repeat (b) and (c) until a termination criterion is met; and
(e) output the current sequence of control points after the termination criterion is met.

15. A system, comprising:
(a) means for computing an initial sequence of control points;
(b) means for evaluating the system by a global cost function that uses internal simulation based on the control points;
(c) means for updating the initial sequence to form a current sequence of control points based on the evaluation;
(d) means for repeating (b) and (c) until a termination criterion is met; and
(e) means for outputting the current sequence of the control points after the termination criterion is met.
